(19) United States
(12) Patent Application Publication
(10) Pub. No.: US 2026/0059551 A1
(43) Pub. Date: Feb. 26, 2026

(54) TECHNIQUES FOR JOINT COMMUNICATION AND RADAR SIGNALS IN WIRELESS COMMUNICATIONS

(71) Applicant: QUALCOMM Incorporated, San Diego, CA (US)

(72) Inventors: Preeti KUMARI, San Diego, CA (US); Shuanshuan WU, San Diego, CA (US); Stelios STEFANATOS, San Diego, CA (US); Kapil GULATI, Belle Mead, NJ (US); Junyi LI, Greentown, PA (US)

(21) Appl. No.: 19/102,818

(22) PCT Filed: Oct. 19, 2023
(86) PCT No.: PCT/US2023/077299

§ 371 Date: Feb. 10, 2025

(30) Foreign Application Priority Data
Oct. 21, 2022 (GR) 20220100867

(51) Int. Cl. H04W 72/25; H04B 10/293

(52) U.S. Cl. CPC H04W 72/25; H04B 10/2931

(57) ABSTRACT

Aspects described herein relate to obtaining an indication of a comb pattern including a collection of non-contiguous time resource locations for transmitting a radar signal that includes a data channel communication, and one of transmitting, using the comb pattern, the radar signal to one or more other UEs over sidelink shared channel resources, or receiving, using the comb pattern, the radar signal from one or more other UEs over the sidelink shared channel resources. Other aspects relate to configuring the UEs with the comb pattern.

### CROSS-REFERENCE TO RELATED APPLICATIONS

This application claims the benefit of Greek Provisional Patent Application No. 20220100867, entitled TECHNIQUES FOR JOINT COMMUNICATION AND RADAR SIGNALS IN WIRELESS COMMUNICATIONS, and filed on Oct. 21, 2022, which is expressly incorporated by reference herein in its entirety.

### FIELD OF THE DISCLOSURE

Aspects of the present disclosure relate generally to wireless communication systems, and more particularly, to techniques for communicating joint communication and radar signals.

### DESCRIPTION OF RELATED ART

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

In 5G NR, for example, devices can transmit radar signals to indicate presence of the device to other nearby devices. In some implementations, the radar signals can be transmitted as, or along with, data signals in a joint communication and radar system.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for wireless communication is provided that includes a processor, memory coupled with the processor, and instructions stored in the memory. The instructions are operable, when executed by the processor, to cause the apparatus to obtain an indication of a comb pattern including a collection of non-contiguous time resource locations for transmitting a radar signal that includes a data channel communication, and one of: transmit, using the comb pattern, the radar signal to one or more other user equipment (UEs) over sidelink shared channel resources; or receive, using the comb pattern, the radar signal from one or more other UEs over the sidelink shared channel resources.

In another aspect, an apparatus for wireless communication is provided that includes a processor, memory coupled with the processor, and instructions stored in the memory. The instructions are operable, when executed by the processor, to cause the apparatus to generate a comb pattern for multiple UEs to use in transmitting, over sidelink resources, a radar signal that includes a data channel communication, and transmit, to the multiple UEs, downlink control information including an indication of the comb pattern, where the comb pattern includes a collection of non-contiguous time resource locations for transmitting the radar signal.

In another aspect, a method for wireless communication at a UE is provided that includes obtaining an indication of a comb pattern including a collection of non-contiguous time resource locations for transmitting a radar signal that includes a data channel communication, and one of transmitting, using the comb pattern, the radar signal to one or more other UEs over sidelink shared channel resources, or receiving, using the comb pattern, the radar signal from one or more other UEs over the sidelink shared channel resources.

In another aspect, a method for wireless communication at a network node is provided that includes generating a comb pattern for multiple UEs to use in transmitting, over sidelink resources, a radar signal that includes a data channel communication, and transmitting, to the multiple UEs, downlink control information including an indication of the comb pattern, where the comb pattern includes a collection of non-contiguous time resource locations for transmitting the radar signal.

In a further aspect, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a diagram illustrating an example of disaggregated base station architecture, in accordance with various aspects of the present disclosure;

FIG. 3 is a block diagram illustrating an example of a user equipment (UE), in accordance with various aspects of the present disclosure;

FIG. 4 is a block diagram illustrating an example of a base station, in accordance with various aspects of the present disclosure;

FIG. 5 illustrates examples of phase sensing for radar signals, in accordance with aspects described herein;

FIG. 6 is a flow chart illustrating an example of a method for transmitting a joint communication and radar (JCR) signal as a radar signal that include sidelink (SL) communications, in accordance with aspects described herein;

FIG. 7 is a flow chart illustrating an example of a method for receiving a JCR signal as a radar signal that include sidelink communications, in accordance with aspects described herein;

FIG. 8 is a flow chart illustrating an example of a method for configuring a UE for transmitting a JCR signal as a radar signal that includes sidelink communications, in accordance with aspects described herein;

FIG. 9 illustrates an example of a resource allocation over a period of time, including a comb pattern of non-overlapping sidelink resources for multiple SL transmitting UEs, in accordance with aspects described herein;

FIG. 10 illustrates another example of a resource allocation over a period of time, including a comb pattern of non-overlapping sidelink resources for multiple SL transmitting UEs, in accordance with aspects described herein;

FIG. 11 illustrates an example of a resource allocation over a period of time, including a comb pattern with some overlapping sidelink resources for multiple SL transmitting UEs, in accordance with aspects described herein

FIG. 12 illustrates an example of a resource allocation over a period of time, including a time and/or frequency comb pattern for multiple SL transmitting UEs, in accordance with aspects described herein; and

FIG. 13 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to assigning time resources in a comb structure for transmitting joint communication and radar (JCR) signals. In some wireless communication technologies, such as fifth generation (5G) new radio (NR), JCR systems can include cooperative JCR systems where some knowledge is shared between the communication and radar systems to improve performance without minimal alteration of the core operation of radar and communication systems, or a co-design of the communication and radar system where a common transmitter or receiver is used for both communication and radar functionalities. Co-designed JCR systems can use a slightly modified waveform generation or receiver processing by the communication and/or radar systems. In an example, at least co-designed JCR systems can allow for spectrum and hardware reuse, which can conserve resource utilization and power consumption at devices communicating the JCR signals.

In one specific example, cyclic prefix (CP)-orthogonal frequency division multiplexing (OFDM) data signals can be used for radar sensing as well. If symbol length is less than radar channel delay spread for radar sensing, a multi-fast Fourier transform (FFT) algorithm can be used for radar detection and estimation. In some examples, multi-FFT per symbol algorithm can meet maximum automotive range requirement of 300 meters in single-target scenario with minimum detectable signal-to-interference-and-noise ratio (SINR) of 15 decibel (dB). One approach to mitigate large symbol energy loss due to long delay spread is to use one-tap frequency domain equalization (FDE) with multi-FFT windows per symbol. For example, for 480 kilohertz (kHz) subcarrier spacing (SCS): First range FFT window for k^{th} symbol can remain the same as the baseline processing (one-tap FDE with single-FFT window per symbol); Second range FFT window for k^{th} symbol can start where the first window corresponding to that symbol ends to fully capture the received k^{th} symbol; Multi-FFT per symbol target detection can be performed based on a first range-Doppler (RD) map estimate, which can have high target SINR for small ranges (with delay bin (d) less than ¼^{th} of FFT size (M_{FFT}), i.e., d<M_{FFT}/4 ), where RD map estimate can have high target SINR for large ranges (d>3M_{FFT}/4), and RD map obtained by adding both the RD map estimates (leads to noise enhancement) can have high target SINR for medium ranges (M_{FFT}/4<d<3M_{FFT}/4). In general, radar sensing using data part can also enable enhanced JCR performance as compared to time division multiplexing (TDM) approach. In addition, for example, 2-RF performance may be better than 1-RF JCR, where 2-RF performance can be achievable with different waveforms (e.g., with no cross-layer interference).

Using JCR signals, for example, contiguous block of data for simultaneous sensing may lead to large communication overhead due to stringent radar sensing needs, such as wide angular field of view (FoV) with high angular resolution, which may use more beams for scanning mode, high velocity (large coherent processing interval (CPI) and range resolution (large bandwidth), high update rate and high density of radars, etc. In addition, for example, data comb transmission in time-frequency domain may be used to meet radar sensing key performance indicator (KPI) requirements without significant reduction in communication data rate. This may also enable better interference management. Examples described herein relate to different time and/or frequency comb designs and signaling for JCR application that can meet radar resolution requirements with less overhead to communication data rate.

Aspects described herein include JCR sidelink resource allocation, including different time and/or frequency comb patterns and/or configurable parameters to reserve resources for simultaneous radar sensing. For example, UEs can have resources allocated for sidelink communications using type 1 sidelink resource allocation, e.g., as defined in 5G NR, where a base station can allocate the resources for each sidelink transmitting UE to use, or type 2 sidelink resource allocation, e.g., as defined in 5G NR, where the base station can allocate a pool of resources from which sidelink transmitting UEs can select for use in transmitting sidelink communications. In either case, the JCR sidelink resource allocations can allow the radar signals to achieve radar resolution requirements with more efficient resource utilization by using sidelink communications as the radar signals. For example, aspects described herein can include the JCR signaling and associated resource allocation concepts, automatic gain control (AGC) signal reservation, search space for physical sidelink control channel (PSCCH) for a time and/or frequency comb pattern, sidelink control information (SCI) and/or downlink control information (DCI) indication or signaling, and/or resource pool pre-configuration, for the chosen data comb pattern and configurable parameters in the time and/or frequency domain, etc. Using the data comb patterns in the time and/or frequency domain can allow for high density of radar signals to improve radar operations, and can enable the radar sensing with low data rate overhead, which can improve resource utilization, and thus communication efficiency and quality at the UE.

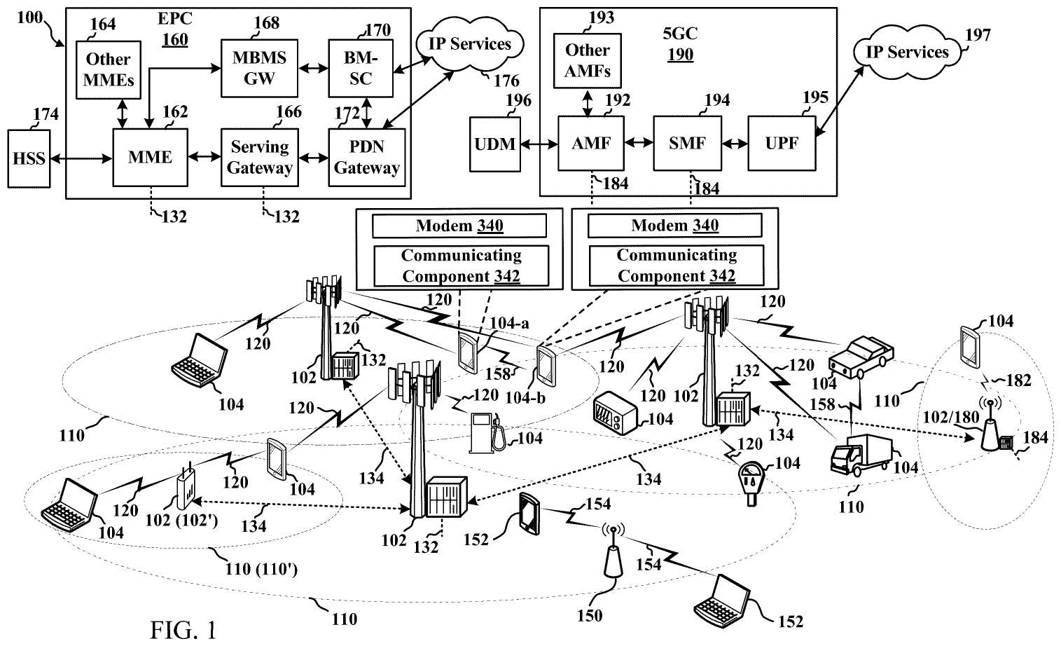

The described features will be presented in more detail below with reference to FIGS. 1-13.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Techniques described herein may be used for various wireless communication systems such as CDMA, TDMA, FDMA, OFDMA, single carrier-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 340 and UE communicating component 342 for configuring a time and/or frequency comb pattern for JCR signals in sidelink communications, in accordance with aspects described herein. In addition, some nodes may have a modem 440 and BS communicating component 442 for configuring UEs for communicating using sidelink resources, in accordance with aspects described herein. Though UE 104-a and 104-b are shown as having the modem 340 and UE communicating component 342 and a base station 102/gNB 180 is shown as having the modem 440 and BS communicating component 442, this is one illustrative example, and substantially any node or type of node may include a modem 340 and UE communicating component 342 and/or a modem 440 and BS communicating component 442 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, head compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 (e.g., UEs 104-a and 104-b) may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS, e.g., BS 102), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In an example, UE 104-a can be a SL transmitting UE that can transmit SL communications to multiple SL receiving UEs 104-b. In this example, the SL transmitting UE 104-a can transmit, to the SL receiving UEs 104-b, SCI to schedule resources over which the SL transmitting UE 104-a transmits SL communications to the SL receiving UEs 104-b (e.g., PSSCH communications). According to aspects described herein, the SL transmitting UE 104-a can transmit SCI that schedules radar communications (e.g., JCR signals) for one or more SL receiving UEs 104-b. For example, UE communicating component 342 of a SL transmitting UE 104-a can transmit SCI that schedules JCR signals in a comb pattern in time and/or frequency. In this example, UE communicating component 342 of a SL receiving UE 104-b can receive the SCI that schedules JCR signals in the comb pattern in time and/or frequency. The SL transmitting UE 104-a and/or SL receiving UE 104-b can accordingly communicate JCR signals based on the comb pattern. In one example, base station 102 can allocate the resources for the SL transmitting UEs (e.g., SL transmitting UE 104-a), and can accordingly schedule the resources in the comb pattern at least in time.

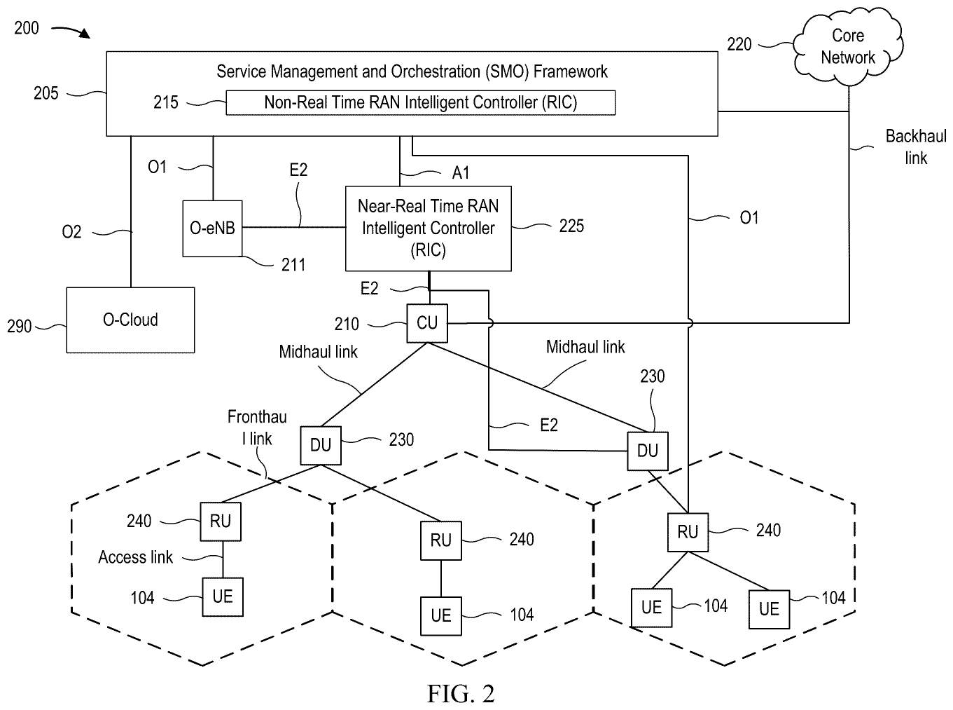

FIG. 2 shows a diagram illustrating an example of disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an Al interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as Al policies).

In an example, BS communicating component 442, as described herein, can be at least partially implemented within a CU 210, and can allocate the resources for sidelink communications for SL transmitting UEs via one or more DUs 230. In another example, BS communicating component 442, as described herein, can be at least partially implemented within a DU 230, and can allocate the resources for sidelink communications for SL transmitting UEs via one or more RUs 240.

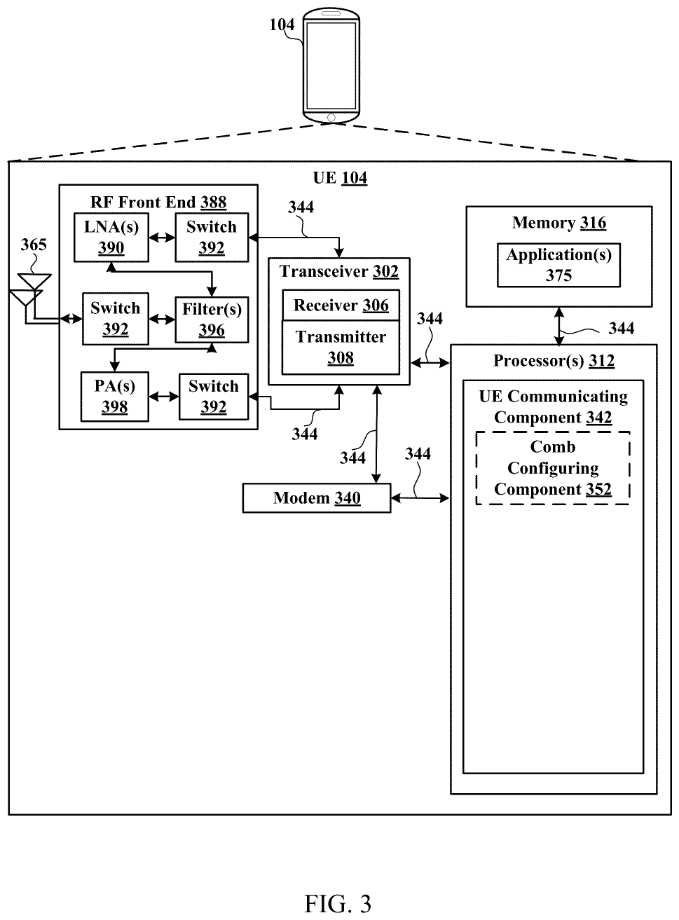

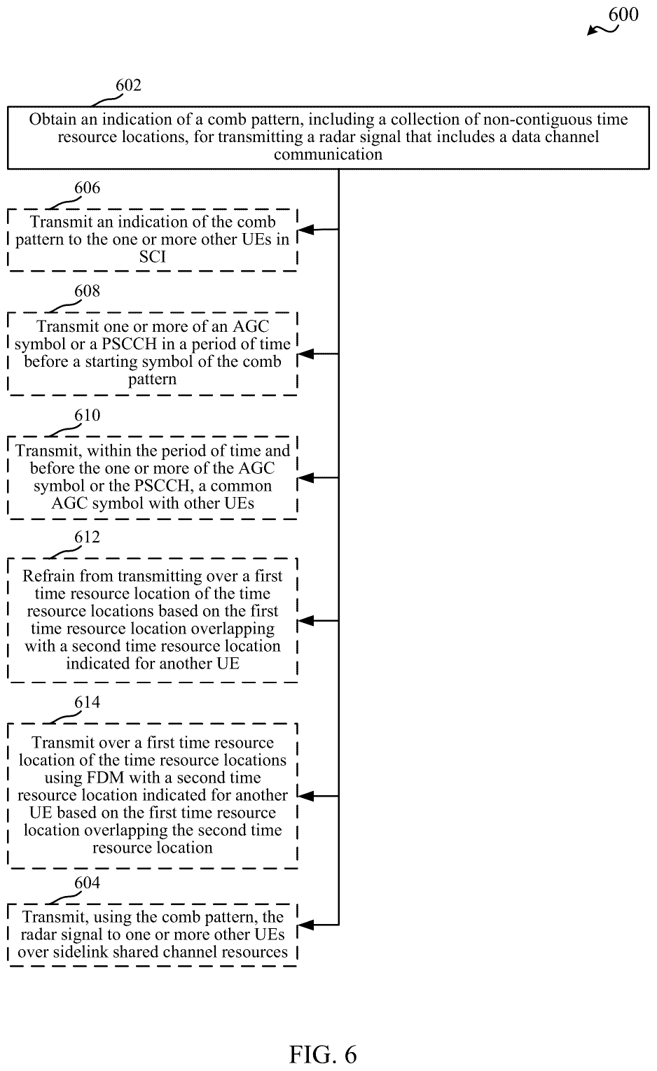

Turning now to FIGS. 3-13, aspects are depicted with reference to one or more components and one or more methods that may perform the actions or operations described herein, where aspects in dashed line may be optional. Although the operations described below in FIGS. 6-8 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 3, one example of an implementation of UE 104 may include a variety of components, some of which have already been described above and are described further herein, including components such as one or more processors 312 and memory 316 and transceiver 302 in communication via one or more buses 344, which may operate in conjunction with modem 340 and/or UE communicating component 342 for configuring a comb pattern for JCR signals in sidelink communications, in accordance with aspects described herein.

In an aspect, the one or more processors 312 can include a modem 340 and/or can be part of the modem 340 that uses one or more modem processors. Thus, the various functions related to UE communicating component 342 may be included in modem 340 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 340 associated with UE communicating component 342 may be performed by transceiver 302.

Also, memory 316 may be configured to store data used herein and/or local versions of applications 375 or UE communicating component 342 and/or one or more of its subcomponents being executed by at least one processor 312. Memory 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory 316 may be a non-transitory computer-readable storage medium that stores one or more computer-executable codes defining UE communicating component 342 and/or one or more of its subcomponents, and/or data associated therewith, when UE 104 is operating at least one processor 312 to execute UE communicating component 342 and/or one or more of its subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one base station 102. Additionally, receiver 306 may process such received signals, and also may obtain measurements of the signals, such as, but not limited to, Ec/Io, signal-to-noise ratio (SNR), reference signal received power (RSRP), received signal strength indicator (RSSI), etc. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, UE 104 may include RF front end 388, which may operate in communication with one or more antennas 365 and transceiver 302 for receiving and transmitting radio transmissions, for example, wireless communications transmitted by at least one base station 102 or wireless transmissions transmitted by UE 104. RF front end 388 may be connected to one or more antennas 365 and can include one or more low-noise amplifiers (LNAs) 390, one or more switches 392, one or more power amplifiers (PAS) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that UE 104 can communicate with, for example, one or more base stations 102 or one or more cells associated with one or more base stations 102. In an aspect, for example, modem 340 can configure transceiver 302 to operate at a specified frequency and power level based on the UE configuration of the UE 104 and the communication protocol used by modem 340.

In an aspect, modem 340 can be a multiband-multimode modem, which can process digital data and communicate with transceiver 302 such that the digital data is sent and received using transceiver 302. In an aspect, modem 340 can be multiband and be configured to support multiple frequency bands for a specific communications protocol. In an aspect, modem 340 can be multimode and be configured to support multiple operating networks and communications protocols. In an aspect, modem 340 can control one or more components of UE 104 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, UE communicating component 342 can optionally include a comb configuring component 352 for receiving, generating, or processing a configuration indicating a comb pattern for communicating radar signals (e.g., JCR signals) in sidelink communications, in accordance with aspects described herein. For example, where the UE 104 is a SL transmitting UE, comb configuring component 352 can receive an indication of at least a time portion of the comb pattern from a base station 102 (e.g., in type 1 sidelink resource allocation) or can generate at least the time portion of the comb pattern (e.g., in type 2 sidelink resource allocation). In an example, where UE 104 is a SL transmitting UE, comb configuring component 352 can transmit a configuration that indicates the time and/or frequency comb pattern for a SL receiving UE to use in communicating JCR signals. For example, where the UE 104 is a SL receiving UE, comb configuring component 352 can receive and/or process the configuration that indicates the comb pattern of time and/or frequency resources.

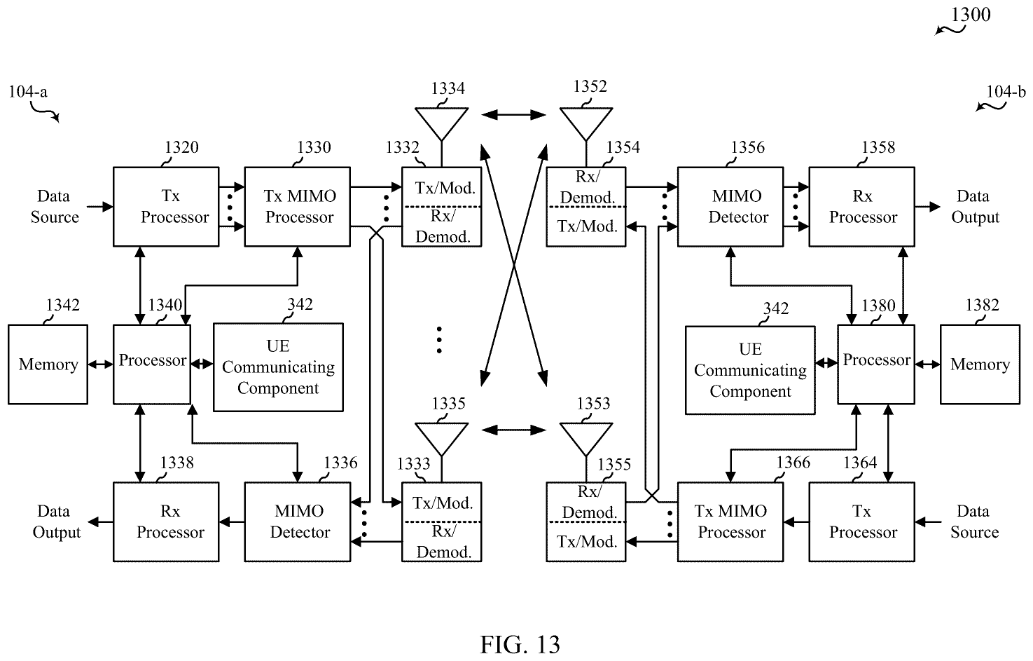

In an aspect, the processor(s) 312 may correspond to one or more of the processors described in connection with the UE in FIG. 13. Similarly, the memory 316 may correspond to the memory described in connection with the UE in FIG. 13.

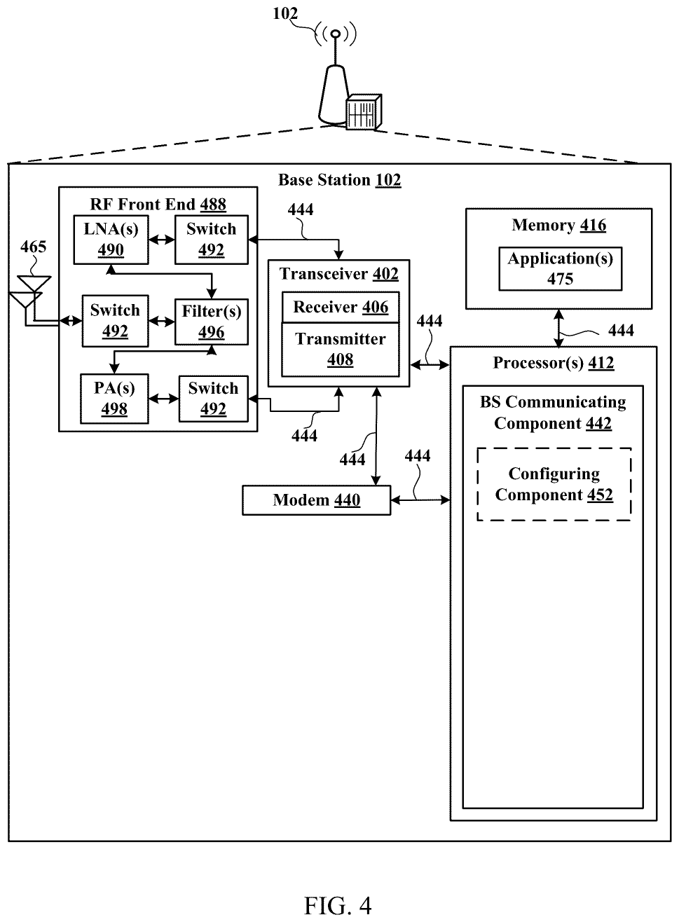

Referring to FIG. 4, one example of an implementation of base station 102 (e.g., a base station 102 and/or gNB 180, as described above) may include a variety of components, some of which have already been described above, but including components such as one or more processors 412 and memory 416 and transceiver 402 in communication via one or more buses 444, which may operate in conjunction with modem 440 and BS communicating component 442 for configuring UEs for communicating using sidelink resources, in accordance with aspects described herein.

The transceiver 402, receiver 406, transmitter 408, one or more processors 412, memory 416, applications 475, buses 444, RF front end 488, LNAs 490, switches 492, filters 496, PAs 498, and one or more antennas 465 may be the same as or similar to the corresponding components of UE 104, as described above, but configured or otherwise programmed for base station operations as opposed to UE operations.

In an aspect, BS communicating component 442 can optionally include a configuring component 452 for configuring at least a time portion of the comb pattern of resources for a SL transmitting UE to use in transmitting SL communications to one or more SL receiving UEs, in accordance with aspects described herein.

In an aspect, the processor(s) 412 may correspond to one or more of the processors described in connection with the base station in FIG. 13. Similarly, the memory 416 may correspond to the memory described in connection with the base station in FIG. 13.

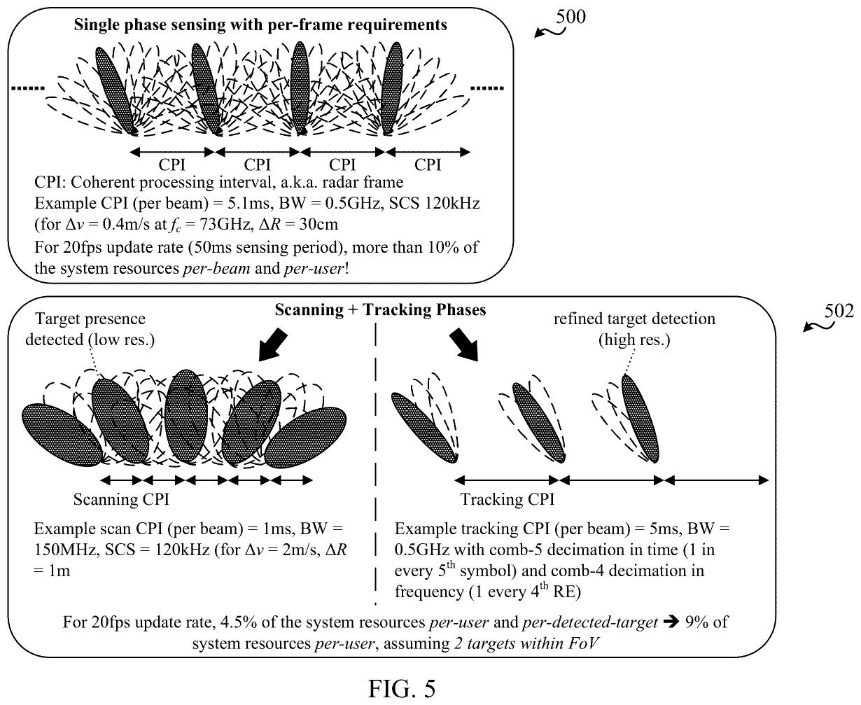

FIG. 5 illustrates examples of phase sensing for radar signals. Communications between devices in automobiles can benefit from high density of radars with high-resolution and high-update rate. Phase sensing can include single phase sensing, as shown at 500, which may lead to large communication overhead with back-to-back comb transmission. In single phase sensing, a UE can be configured with a coherent processing interval (CPI, also referred to as a radar frame) during which the UE can sense a radar signal. In this example, with a 20 frame per second update rate (50 millisecond sensing period), more than 10% of the system resources can be used per beam and per UE.

Phase sensing can include multi-phase sensing, as shown at 502, which may enable radar sensing with low data rate overhead with sparse comb pattern. For example, in a first (scanning) phase, target presence can be detected with low resolution, and in a second (tracking) phase, target direction for detected targets can be refined with high resolution. The CPI for the scanning phase can be smaller than that used in single phase sensing, and the overhead can still be smaller than single phase scanning—e.g., with a 20 frame per second update rate, than 4.5% of the system resources can be used per beam and per UE, and 9% of system resources per user can be used assuming two targets within field of view (FoV).

In 5G NR, interlaced channel structure can be used for sidelink communications in unlicensed band, which can allow for achieving occupied channel bandwidth (OCB) requirements. A transmission from a SL UE can occupy one or multiple interlaced resource RB groups, where one interlaced RB group includes RBs that are evenly spaced in frequency within the available channel bandwidth. In 5G NR, the interlaced pattern is adopted with uniform spacing for entire channel bandwidth, and this structure may not be sufficient and flexible enough to reduce communication data rate for radar sensing with desired requirements. Accordingly, aspects described herein relate to a time (and/or frequency) comb pattern for a UE, which can be configured for the UE by a base station (e.g., in type 1 sidelink resource allocation) or otherwise selected by the UE (e.g., in type 2 sidelink resource allocation). The time comb pattern can include enhanced uniform and/or non-uniform comb patterns within a configurable transmission window of time of the UE. In another example, the time comb pattern may be such that UEs may or may not overlap in time periods for transmissions. Where UEs overlap, for example, the frequency resources of the bandwidth assigned for the UE can be further divided (e.g., in a comb pattern or otherwise) among the UEs. In one example, a SL transmitting UE can transmit an SCI indication of the time (and/or) frequency comb pattern for JCR signals, where the JCR signals can include a sidelink communications signal that is also used for radar sensing.

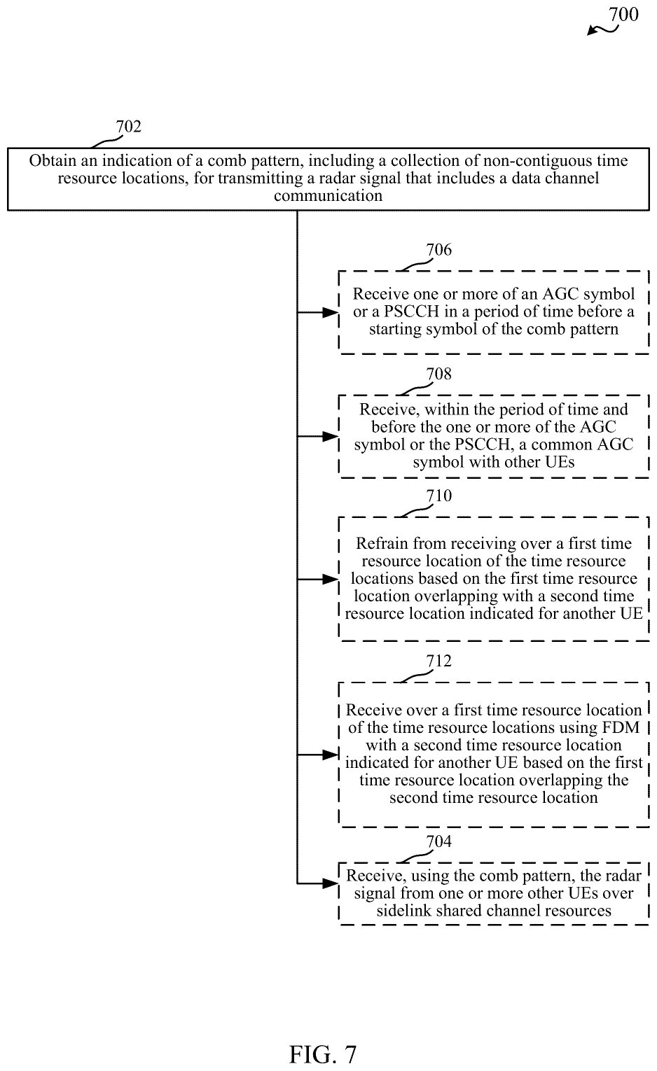

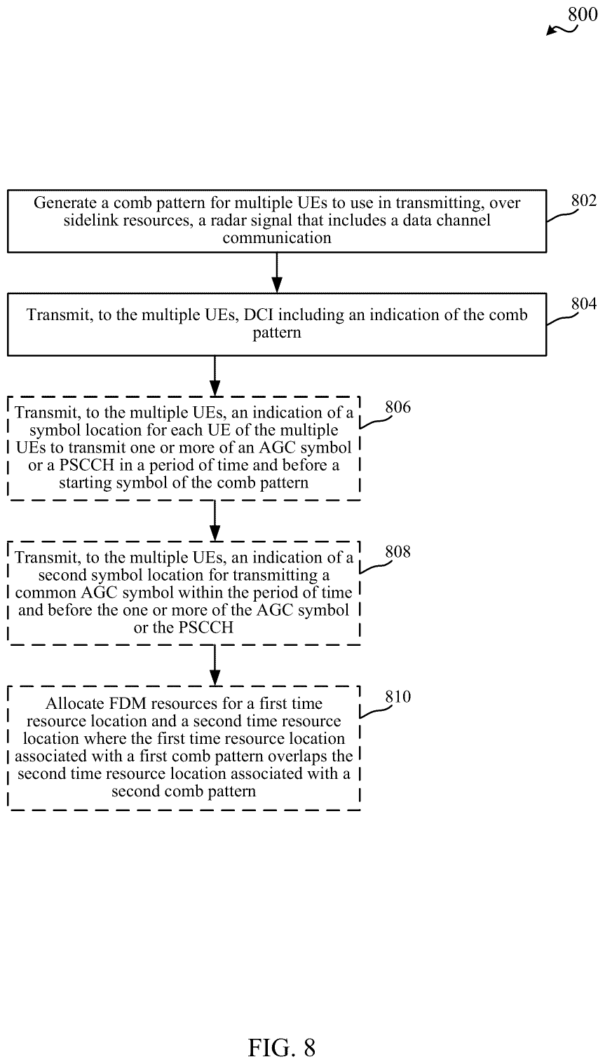

FIG. 6 illustrates a flow chart of an example of a method 600 for transmitting a JCR signal as a radar signal that includes sidelink communications, in accordance with aspects described herein. FIG. 7 illustrates a flow chart of an example of a method 700 for receiving a JCR signal as a radar signal that includes sidelink communications, in accordance with aspects described herein. FIG. 8 illustrates a flow chart of an example of a method 800 for configuring a UE for transmitting a JCR signal as a radar signal that includes sidelink communications, in accordance with aspects described herein. In an example, a UE functioning as a SL transmitting UE 104-a in sidelink communications, can perform the functions described in method 600 using one or more of the components described in FIGS. 1 and 3. In an example, a UE functioning as a SL receiving UE 104-b in sidelink communications, can perform the functions described in method 700 using one or more of the components described in FIGS. 1 and 3. In an example, a network node (e.g., a base station 102, gNB, a monolithic base station 102 or gNB, a disaggregated portion of a base station 102 or gNB, etc.) can perform the functions described in method 800 using one or more of the components described in FIGS. 1 and 4. Methods 600, 700, and 800 are described in conjunction with one another for ease of explanation; however, the methods 600, 700, and 800 are not required to be performed together and indeed can be performed independently using separate devices.

In method 600, at Block 602, an indication of a comb pattern, including a collection of non-contiguous time resource locations, for transmitting a radar signal that include a data channel communication can be obtained. In an aspect, comb configuring component 352, e.g., in conjunction with processor(s) 312, memory 316, transceiver 302, UE communicating component 342, etc., of a SL transmitting UE 104-a, can obtain the indication of the comb pattern, including the collection of non-contiguous time resource locations, for transmitting the radar signal that includes the data channel communication. In one example, the SL transmitting UE 104-a can be allocated with the pool of resources for sidelink communications in a Type 2 SL resource allocation, which may include a base station 102 specifying the pool of resources from which SL UEs can select resources for transmitting SL communications. In this example, comb configuring component 352 can accordingly autonomously select resources from the pool of resources for transmitting sidelink communications in JCR signals, and can generate SCI to indicate the selected resources to other SL receiving UEs, where the resources can be based on (and can be indicated as) a time (and/or frequency) comb pattern.

In another example, SL transmitting UE 104-a can obtain the indication of the comb pattern by receiving the indication of the comb pattern from a network node allocating at least a time portion of the comb pattern in Type 1 SL resource allocation. For example, comb configuring component 352 can receive the indication of the comb pattern from the network node in downlink control information (DCI) that schedules time and/or frequency resources for sidelink communications. In any case, for example, the indication of the comb pattern can include one or more parameters related to determining the comb pattern within a period of time, such as an index of a starting time instance (e.g., an index of a starting symbol, such as an orthogonal frequency division multiplexing (OFDM) symbol, single carrier-frequency division multiplexing (SC-FDM) symbol, etc. within a slot of multiple symbols), a uniform spacing or periodicity of symbols defining the comb pattern over the slot or multiple slots or other collection of symbols, an index of a last symbol in the period of time, a value of the total number of symbols in the period of time, a number of periods of time that follow the comb pattern, or a repetition pattern (or associated parameters) for the periods of time, etc.

For example, in method 800, at Block 802, a comb pattern can be generated for multiple UEs to use in transmitting, over sidelink resources, a radar signal that includes a data channel communications. In an aspect, configuring component 452, e.g., in conjunction with processor(s) 412, memory 416, transceiver 402, BS communicating component 442, etc., can generate the comb pattern for the multiple UEs to use in transmitting, over sidelink resources, the radar signal that includes the data channel communication. For example, configuring component 452 can generate the comb pattern to include a portion of time resources for a given SL transmitting UE or each of multiple SL transmitting UEs in Type 1 SL resource allocation, as described further herein.

In this example, in method 800, at Block 804, DCI including an indication of the comb pattern can be transmitted to the multiple UEs. In an aspect, BS communicating component 442, e.g., in conjunction with processor(s) 412, memory 416, transceiver 402, etc., can transmit, to the multiple UEs, a DCI including the indication of the comb pattern. For example, BS communicating component 442 can transmit the DCI in a downlink control channel (e.g., physical downlink control channel (PDCCH)) scheduled for each of the multiple UEs, which may include transmitting the specific comb pattern for a given UE in an associated downlink control channel. In an example, comb configuring component 352 of a SL transmitting UE, in this example, can receive the indication of the comb pattern in DCI over an associated downlink control channel with the network node.

Whether received from the network node or generated by the SL transmitting UE, comb configuring component 352 can transmit sidelink communications based on the comb pattern. For example, in method 600, optionally at Block 604, the radar signal can be transmitted to one or more other UEs over sidelink shared channel resources and using the comb pattern. In an aspect, UE communicating component 342, e.g., in conjunction with processor(s) 312, memory 316, transceiver 302, etc., of a SL transmitting UE 104-a, can transmit, using the comb pattern, the radar signal to one or more other UEs (e.g., SL receiving UEs) over sidelink shared channel resources (e.g., PSSCH). In one example, as described above and further herein, the one or more other UEs can be notified of the comb pattern used by the SL transmitting UE 104-a for transmitting the SL communications.

For example, in method 600, optionally at Block 606, an indication of the comb pattern can be transmitted to the one or more other UEs in SCI. In an aspect, comb configuring component 352, e.g., in conjunction with processor(s) 312, memory 316, transceiver 302, UE communicating component 342, etc., of a SL transmitting UE 104-a, can transmit the indication of the comb pattern to the one or more UEs in SCI. For example, comb configuring component 352 can transmit the indication of the comb pattern, as received or generated, to one or more SL receiving UEs in SCI transmitted over a control channel resources (e.g., PSCCH).

In method 700, at Block 702, an indication of a comb pattern, including a collection of non-contiguous time resource locations, for transmitting a radar signal that include a data channel communication can be obtained. In an aspect, comb configuring component 352, e.g., in conjunction with processor(s) 312, memory 316, transceiver 302, UE communicating component 342, etc., of a SL receiving UE 104-b, can obtain the indication of the comb pattern (e.g., from a SL transmitting UE 104-a or a network node, as described above), including the collection of non-contiguous time resource locations, for transmitting the radar signal that includes the data channel communication. For example, comb configuring component 352 can receive the indication of the comb pattern in SCI transmitted by a SL transmitting UE 104-a over a control channel resources (e.g., PSCCH), in DCI transmitted by a network node over control channel resources (e.g., PDCCH), etc.

In method 700, optionally at Block 704, the radar signal can be received from the one or more other UEs over sidelink shared channel resources using the comb pattern. In an aspect, UE communicating component 342, e.g., in conjunction with processor(s) 312, memory 316, transceiver 302, etc., of a SL receiving UE 104-b, can receive, using the comb pattern, the radar signal from one or more other UEs (e.g., SL transmitting UEs) over sidelink shared channel resources (e.g., PSSCH). In one example, as described above and further herein, the one or more other UEs can be notified of the comb pattern used by the SL transmitting UE 104-a for transmitting the SL communications, and can accordingly receive the radar signal(s) based on the comb pattern (e.g., in time and/or frequency).

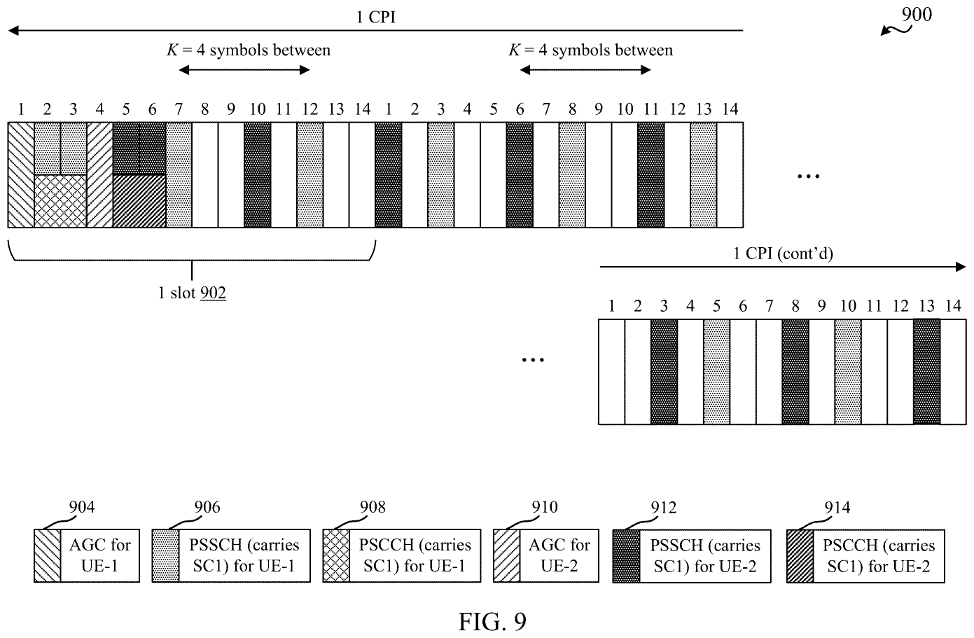

Referring to FIG. 9, an example of a resource allocation 900 over a period of time, including a comb pattern of non-overlapping sidelink resources for multiple SL transmitting UEs, is illustrated, in accordance with aspects described herein. Resource allocation 900 includes multiple slots, such as slot 902, including multiple symbols (e.g., 14 symbols). A first slot (e.g., slot 1 902) can include an AGC symbol for a first UE (UE-1) 904 (e.g., symbol 1 of the first slot), one or more symbols that include PSSCH (including SCI) for UE-1 906 and PSCCH (including SCI) for UE-1 908 (e.g., symbols 2 and 3 of the first slot), an AGC symbol for a second UE (UE-2) 910 (e.g., symbol 4 of the first slot), and one or more symbols that include PSSCH (including SCI) for UE-2 912 and PSCCH (including SCI) for UE-2 914 (e.g., symbols 5 and 6 of the first slot). In addition, resource allocation 900 includes a comb pattern of resources in time allocated to UE-1, which include non-contiguous resources in time in a uniform spacing or pattern of a number, K, symbols between each “tooth” or allocated symbol of the comb (or can indicate a uniform pattern period of a period between the allocated symbols). For example, for UE-1, K=4 symbols with starting symbol 7 for PSSCH communications 906. Thus, with 4 symbols in between, PSSCH communications for UE-1 906 can be at symbols 7 and 12 of the first slot 902, symbols 3, 8, and 13 of a subsequent slot, etc. within a CPI. For example, for UE-2, K=4 symbols with starting symbol 10 for PSSCH communications 912. Thus, with 4 symbols in between, PSSCH communications for UE-2 912 can be at symbol 10 of the first slot 902, symbols 1, 6, and 11 of a subsequent slot, etc. within a CPI. In this example, the SL transmitting UEs, UE-1 and UE-2, are allocated sidelink communication resources in non-overlapping resources over the period of time (e.g., the CPI) according to uniform comb patterns starting at different symbols.

In an example, the number of symbols, K, between sidelink communications can be agreed between, or otherwise configured to be the same value for, both UEs. Using the same spacing and different start symbol, in this regard, can ensure no collision between different UEs. Various options can be provided for AGC/PSCCH resource location within the period of time. In the depicted example, the first start symbol allocated within a CPI for a given UE is AGC symbol for that UE only. For example, the first start symbol of a UE (e.g., for transmitting AGC symbol) can be between the first symbol of the first slot 902 and a symbol represented by a stopSymindex (such as ‘7’) in the slot with some additional constraints. For example, configuring a parameter stopSymindex can allow for improved efficiency in searching for PSCCH/AGC symbols and efficient slot usage by limiting the search to the number of symbols between the first symbol and the symbol at stopSymindex. In one example, the next two or three symbols after the first start symbol allocated to a UE can include PSCCH. In the depicted example, a first symbol of slot can be used as a AGC symbol by a first UE in Type 1 SL resource allocation. Then, after PSCCH symbols of first UE, a second UE can transmit its AGC symbol followed by PSCCH symbols either immediately or after a few symbols. For example, the indication of the comb pattern for UE-2 can indicate starting symbol at symbol 4, and the UE-2 can transmit its AGC at starting symbol 4 followed by PSCCH in one or more subsequent symbols. In another example, UE-1 can determine to transmit PSCCH from the symbol after symbol 1 (e.g., symbol 2) until the symbol (e.g., symbol 3) that is before the start symbol for the next UE (e.g., symbol 4).

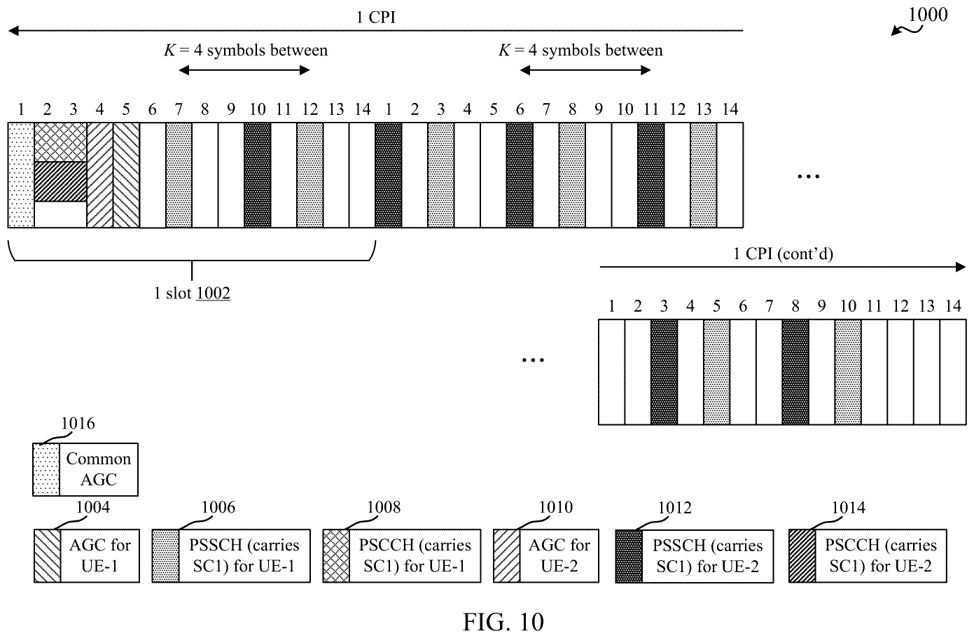

Referring to FIG. 10, another example of a resource allocation 1000 over a period of time, including a comb pattern of non-overlapping sidelink resources for multiple SL transmitting UEs, is illustrated, in accordance with aspects described herein. Resource allocation 1000 includes multiple slots, such as slot 1002, including multiple symbols (e.g., 14 symbols). A first slot (e.g., slot 1 1002) can include a common AGC symbol 1016 for multiple UEs, after which the multiple UEs can each transmit PSCCH in one or more slots, including one or more symbols that include PSCCH (including SCI) for a first UE (UE-1) 1008 and PSCCH (including SCI) for a second UE (UE-2) 1014 (e.g., symbols 2 and 3 of the first slot). The first slot can also include an AGC symbol for UE-2 1010 (e.g., symbol 4 of the first slot), and an AGC symbol for UE-1 1004 (e.g., symbol 5 of the first slot). This scheme may be more robust for resource allocations with overlapping symbols, as shown and described herein below.

In addition, resource allocation 1000 includes a comb pattern of resources in time allocated to UE-1, which include non-contiguous resources in time in a uniform spacing or pattern of a number, K, symbols between each “tooth” or allocated symbol of the comb. For example, for UE-1, K=4 symbols with starting symbol 7 for PSSCH communications 1006. Thus, with 4 symbols in between, PSSCH communications for UE-1 1006 can be at symbols 7 and 12 of the first slot 1002, symbols 3, 8, and 13 of a subsequent slot, etc. within a CPI. For example, for UE-2, K=4 symbols with starting symbol 10 for PSSCH communications 1012. Thus, with 4 symbols in between, PSSCH communications for UE-2 1012 can be at symbol 10 of the first slot 1002, symbols 1, 6, and 11 of a subsequent slot, etc. within a CPI. In this example, the SL transmitting UEs, UE-1 and UE-2, are allocated sidelink communication resources in non-overlapping resources over the period of time (e.g., the CPI) according to uniform comb patterns starting at different symbols.

In one example, selection/indication of comb parameters can either be assisted by DCI signaling of network node (e.g., in Type 1 SL resource allocation) or can be indicated using SCI signaling (e.g., first stage SCI signaling, SCI-1, e.g., in Type 2 SL resource allocation). The comb parameters to be signaled/indicated can include, uniform spacing K, start data/sensing symbol index in the first slot, end symbol index in a CPI, total number of symbols, number of CPIs that follows the same comb pattern and repetition interval of these CPIs, etc., as described. In one example, a resource pool can be configured with a given stopSymindex and uniform spacing K. In another example, these parameters can be made a semi-static or dynamically configurable resource pool parameter (e.g., using RRC signaling, media access control-control element (MAC-CE), DCI and/or the like).

In accordance with the examples described above, in method 600, optionally at Block 608, one or more of an AGC symbol or a PSCCH can be transmitted in a period of time before the starting symbol of the comb pattern. In an aspect, UE communicating component 342, e.g., in conjunction with processor(s) 312, memory 316, transceiver 302, etc., of a SL transmitting UE 104-a, can transmit the one or more of the AGC symbol or the PSCCH in the period of time before the starting symbol of the comb pattern. As described, the starting symbol can be indicated in the indication of the comb pattern, as obtained, or can otherwise be determined and indicated by the SL transmitting UE 104-a in generating the comb pattern. In any case, for example, comb configuring component 352 can determine the symbols for transmitting the AGC symbol and/or PSCCH (and/or PSSCH with SCI) in one or more symbols based on the starting symbol, and UE communicating component 342 can accordingly transmit the AGC symbol (and/or PSCCH and/or PSSCH).

As described, in one example, the symbols to use for AGC and/or PSCCH (and/or PSSCH with SCI) can be configured by a network node. For example, in method 800, optionally at Block 806, an indication of a symbol location for each UE of the multiple UEs to transmit one or more of an AGC symbol or a PSCCH in a period of time and before the starting symbol of the comb pattern can be transmitted. In an aspect, configuring component 452, e.g., in conjunction with processor(s) 412, memory 416, transceiver 402, BS communicating component 442, etc., can transmit, to the multiple UEs, an indication of the symbol location for each UE of the multiple UEs to transmit one or more of an AGC symbol or a PSCCH in the period of time and before the starting symbol of the comb pattern. For example, configuring component 452 can transmit the indication of the symbol location as part of the comb pattern or as a separate transmission or configuration to the multiple UEs (e.g., to each UE individually or otherwise).

In method 700, optionally at Block 706, one or more of an AGC symbol or a PSCCH can be received in a period of time before the starting symbol of the comb pattern. In an aspect, UE communicating component 342, e.g., in conjunction with processor(s) 312, memory 316, transceiver 302, etc., of a SL receiving UE 104-b, can receive the one or more of the AGC symbol or the PSCCH in the period of time before the starting symbol of the comb pattern. For example, the resources used for the AGC symbol and/or the PSCCH can be known based on the starting symbol of the period of time and the stop symbol, as described above. As such, for example, UE communicating component 342 can obtain an AGC symbol in the first symbol (or indicated starting symbol) of the period of time, and can use the AGC symbol to adjust an automatic gain control for receiving PSCCH for the associated SL transmitting UE in a next one or more symbols. In an example, UE communicating component 342 can search for AGC symbols and/or associated PSCCH in symbols starting with a first or starting symbol and ending with an indicated stopping symbol such to limit the search space, as described above. Comb configuring component 352 of the SL receiving UE 104-b can then use SCI received in the PSCCH to determine comb patterns for the SL transmitting UEs, as described above.

In accordance with another example described above, in method 600, optionally at Block 610, a common AGC symbol with other UEs can be transmitted, within a period of time and before the one or more of an AGC symbol or a PSCCH. In an aspect, UE communicating component 342, e.g., in conjunction with processor(s) 312, memory 316, transceiver 302, etc., of a SL transmitting UE 104-a, can transmit, within the period of time and before the one or more of the AGC symbol or the PSCCH, the common AGC symbol with other UEs. As described, a resource location for the common AGC can be indicated in the indication of the comb pattern, as obtained, or can otherwise be determined and indicated by the SL transmitting UE 104-a in generating the comb pattern. In any case, for example, comb configuring component 352 can determine the symbol for transmitting the common AGC symbol, and UE communicating component 342 can accordingly transmit the AGC symbol along with other UEs.

As described, in one example, the symbols to use for common AGC can be configured by a network node. For example, in method 800, optionally at Block 808, an indication of a second symbol location for transmitting a common AGC within the period of time and before the one or more of the AGC symbol or a PSCCH can be transmitted. In an aspect, configuring component 452, e.g., in conjunction with processor(s) 412, memory 416, transceiver 402, BS communicating component 442, etc., can transmit, to the multiple UEs, the indication of the second symbol location for transmitting the common AGC symbol within the period of time and before the one or more of the AGC symbol or a PSCCH. For example, configuring component 452 can transmit the indication of the second symbol location as part of the comb pattern or as a separate transmission or configuration to the multiple UEs (e.g., to each UE individually or otherwise).

In method 700, optionally at Block 708, a common AGC symbol with other UEs can be received within the period of time and before the one or more of the AGC symbol or the PSCCH. In an aspect, UE communicating component 342, e.g., in conjunction with processor(s) 312, memory 316, transceiver 302, etc., of a SL receiving UE 104-b, can receive, within the period of time and before the one or more of the AGC symbol or the PSCCH, the common AGC with other UEs (e.g., a common AGC transmitted by multiple SL transmitting UEs). For example, the resources used for the common AGC symbol can be known based on the starting symbol of the period of time, as described above. As such, for example, UE communicating component 342 can obtain the common AGC symbol in the first symbol (or indicated starting symbol) of the period of time, and can use the AGC symbol to adjust an automatic gain control for receiving PSCCH for multiple associated SL transmitting UEs in a next one or more symbols. Comb configuring component 352 of the SL receiving UE 104-b can then use SCI received in the PSCCH to determine comb patterns for the SL transmitting UEs, as described above.

In the above examples, non-contiguous data transmission in time domain is provided from both UE-1 and UE-2 with no overlapping symbols. In one example, this can be achieved based on a uniform spacing K₁ for UE-1 and a non-uniform spacing set for UE-2 based on chosen K₁ for UE-1 to enforce no overlapping symbols. For example, a resource pool can be configured (e.g., by a network node) with a given K₁ and set of non-unform spacing and UEs only use these spacing parameters. In another example, spacing set parameters can be made a semi-static or dynamically configurable resource pool parameter. For example, configuring component 452 of a network node can configure a first SL transmitting UE with the indication of the comb pattern including the uniform parameter(s) (e.g., a value K for a number of symbols between PSSCH resource allocations), and can configure one or more second SL transmitting UEs with indications of comb patterns including explicit symbol indices that do not overlap with the first UE based on the K value.

In one example, selection/indication of comb parameters can be assisted by DCI signaling of gNB (e.g., in Type 1 SL resource allocation) or can be indicated using SCI (e.g., SCI-1, in Type 2 SL resource allocation). The comb parameters to be signaled/indicated can include, uniform spacing K₁, start data/sensing symbol index in the first slot, end symbol index in a CPI, total number of symbols, number of CPIs that follows the same comb pattern and repetition interval of these CPIs, etc. The parameters may also include a bitmap for the given CPI to indicate which symbols are being used for a given CPI, or configuration parameters for a given type of non-uniform spacing, etc. In one example, the parameters may include or otherwise indicate a nested pattern that is obtained by nesting two (or multiple) uniform patterns with different inter-subcarrier spacing. The inter-subcarrier spacing in the two-level (or multiple-level) nested pattern can be given by {1^{(M)}, (M+1)^{(N)}}, where M is the number of subcarriers in the first uniform pattern and N is the number of subcarriers in the second uniform pattern. Note a^{(b)} represents b repetitions of a. In this case, the parameters or other signaling can be used to indicate M and/or N values.

In another example, both (or all) UEs can have non-uniform spacing sets and can enforce no overlapping symbols. For example, a resource pool can be configured with a given set of non-uniform spacing sets and UEs only use this spacing sets. In another example, spacing sets parameters can be made a semi-static or dynamically configurable resource pool parameter. For example, configuring component 452 of a network node can configure each SL transmitting UE with the indication of the comb pattern including explicit symbol indices that do not overlap with other UEs.

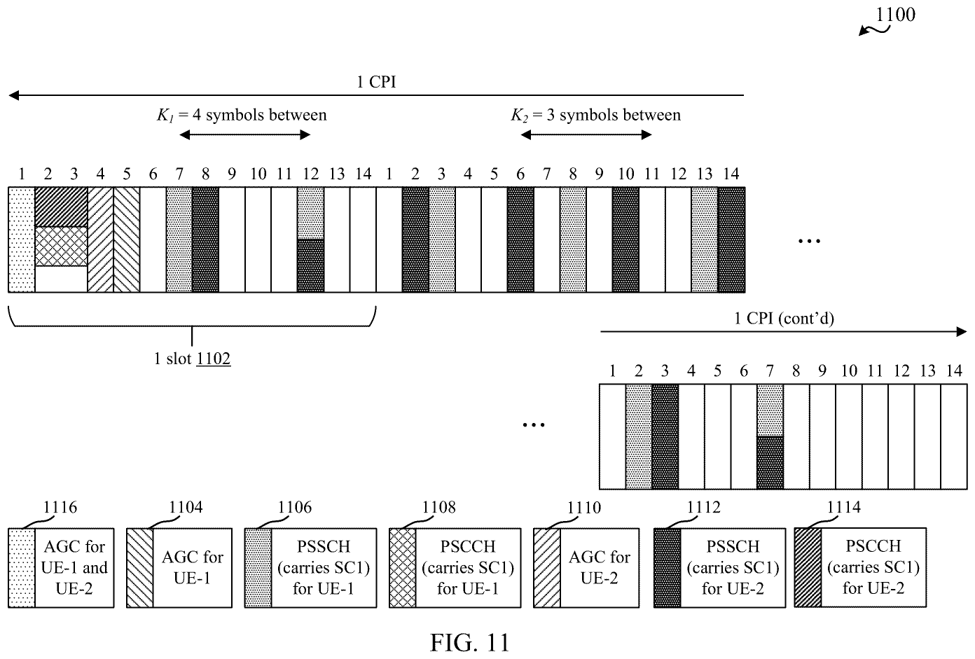

In other examples, the UEs may be scheduled with at least some overlapping symbols, in which case one or more UEs can refrain from transmitting SL communications over the overlapping resources or can transmit the SL communications in a frequency division multiplexed (FDM) manner. In some examples, the indication of the comb pattern can indicate the resources, including overlapping resources, and/or parameters for transmitting overlapping SL communications in the FDM manner. An example is shown in FIG. 11.

FIG. 11 illustrates an example of a resource allocation 1100 over a period of time, including a comb pattern with some overlapping sidelink resources for multiple SL transmitting UEs, in accordance with aspects described herein. Resource allocation 1100 includes multiple slots, such as slot 1102, including multiple symbols (e.g., 14 symbols). A first slot (e.g., slot 1 1102) can include a common AGC symbol 1116 for a first UE (UE-1) and a second UE (UE-2), after which the multiple UEs can each transmit PSCCH in one or more slots, including one or more symbols that include PSCCH (including SCI) for UE-1 1108 and PSCCH (including SCI) for UE-2 1114 (e.g., symbols 2 and 3 of the first slot). The first slot can also include an AGC symbol for UE-2 1110 (e.g., symbol 4 of the first slot), and an AGC symbol for UE-1 1104 (e.g., symbol 5 of the first slot).

In addition, resource allocation 1100 includes a comb pattern of resources in time allocated to UE-1, which include non-contiguous resources in time in a uniform spacing or pattern of a number, K₁, symbols between each “tooth” or allocated symbol of the comb. For example, for UE-1, K₁=4 symbols with starting symbol 7 for PSSCH communications 1106. Thus, with 4 symbols in between, PSSCH communications for UE-1 1106 can be at symbols 7 and 12 of the first slot 1102, symbols 3, 8, and 13 of a subsequent slot, etc. within a CPI. For example, for UE-2, K₂=3 symbols with starting symbol 8 for PSSCH communications 1112. Thus, with 3 symbols in between, PSSCH communications for UE-2 1112 can be at symbols 8 and 12 of the first slot 1102, symbols 2, 6, 10, and 14 of a subsequent slot, etc. within a CPI. In this example, PSSCH resources for UE-1 and UE-2 may overlap, such as in symbol 12 of the first slot 1102.

For example, uniform spacing K₁ can be configured for UE-1 and uniform spacing K₂ can be configured for UE-2 with optional different start symbol than UE-1. When the k^{th} symbol is configured for both UE-1 and UE-2, the symbol can be skipped in one or both of UE-1 or UE-2, or the symbol can be used in FDM, as described above and further herein. Within a given CPI, a first symbol can be used for AGC symbol corresponding to both (or all) UEs transmission, and a next two/three symbols may include PSCCH for different UEs (e.g., UE-1 and UE-2 and/or other UEs) in FDM. Symbols after PSCCH transmission can include additional AGC symbols for individual UEs (e.g., UE-1, UE-2, and/or other UEs). In this regard, for example, a common symbol can be used for calibrating AGC by using orthogonal transmission, such as AGC symbols for two or more users in FDM (either using comb structure or different subchannels).

In one case, selection of spacings and AGC symbol placement can be assisted by DCI signaling of gNB in Type 1 SL resource allocation, and thus in this example, configuring component 452 can transmit a configuration (e.g., in the indication of comb pattern or otherwise) including one or more parameters indicating AGC symbol placement, PSCCH symbol placement, etc. In another example, selection of spacings and AGC symbol placement can be indicated using SCI signaling (e.g., SCI-1) in Type 2 SL resource allocation, as described above. In this example, comb configuring component 352 of a SL transmitting UE 104-a can transmit a configuration (e.g., in the indication of comb pattern or otherwise) including one or more parameters indicating AGC symbol placement, PSCCH symbol placement, etc. to a SL receiving UE 104-b. In one example, configuring component 452 of a network node can configure a resource pool with a given K₁ and K₂ along with AGC symbol placement. Comb configuring component 352 of one or more UEs can receive and process the configuration to determine the resource pool and use the resource pool according to K₁ or K₂ and/or with AGC symbol placement, as described above. In another example, spacing parameters and AGC symbol placement can be made a semi-static or dynamically configurable resource pool parameter.

In some examples, this scheme can be extended to additional UEs (e.g., 3 UEs, greater than 3 UEs, etc.) with additional parameters to ensure AGC is set up properly for the UEs. For example for three UEs, the AGC can be properly setup by skipping the common symbol in UE-3, or using the common symbol in FDM mode between concerned UEs (e.g., UE-2 and UE-3) with additional AGC symbol for UE-3 and UE-2 transmissions, etc. In an example, for uniform and non-uniform interleaved data comb design in time domain with overlapping symbols, signaling can be provided as described above with respect to the non-overlapping examples. For instance, and as described above, the indication of the comb pattern (as generated and/or transmitted by the SL transmitting UE, as received by the SL transmitting UE from a network node, as received by the SL receiving UE from an SL transmitting UE or network node, etc.) can include parameters indicating the K value, starting symbol index, stop symbol index, number of repetitions, etc., along with overlap-specific parameters, such as frequency resources for FDM, etc. Similarly, for non-unform interleaved data comb design in time domain with overlapping symbols, signaling can be provided as described above with respect to the non-overlapping examples.

For example, in method 800, optionally at Block 810, FDM resources can be allocated for a first time resource location and a second time resource location where the first time resource location associated with a first comb pattern overlaps the second time resource location associated with a second comb pattern. In an aspect, configuring component 452, e.g., in conjunction with processor(s) 412, memory 416, transceiver 402, BS communicating component 442, etc., can allocate the FDM resources for the first time resource location and the second time resource location where the first time resource location associated with the first comb pattern overlaps the second time resource location associated with the second comb pattern. As described above, where the network node configures overlapping time resource locations for multiple UEs, it can configure frequency resources to allow the UEs to transmit SL communications in an FDM manner over the time resource location(s) that are overlapping (e.g., in Type 1 SL resource allocation). In another example, configuring component 452 can configure the UEs with one or more parameters for determining how to allocated frequency resources in time resource locations that overlap in time (e.g., in Type 2 SL resource allocation), such as by indicating which UEs use which frequency resources, an identifier for determining an ordering or frequency resources, etc.

In one example, as described above, in method 600, optionally at Block 612, transmitting over a first time resource location of the time resource locations based on the first time resource location overlapping with a second time resource location indicated for another UE can be refrained from. In an aspect, UE communicating component 342, e.g., in conjunction with processor(s) 312, memory 316, transceiver 302, etc., of a SL transmitting UE 104-a, can refrain from transmitting over the first time resource location of the time resource locations based on the first time resource location overlapping with the second time resource location indicated for another UE. For example, refraining from transmitting, in this regard, can prevent interference over the time resource location for one or more SL receiving UEs receiving SL communications from the another UE. In one example, comb configuring component 352 of a SL transmitting UE 104-a can also generate or modify the comb configuration to remove or otherwise not indicate the time resource location that is overlapping.

In method 700, optionally at Block 710, receiving over a first time resource location of the time resource locations based on the first time resource location overlapping with a second time resource location indicated for another UE can be refrained from. In an aspect, UE communicating component 342, e.g., in conjunction with processor(s) 312, memory 316, transceiver 302, etc., of a SL receiving UE 104-b, can refrain from receiving over the first time resource location of the time resource locations based on the first time resource location overlapping with the second time resource location indicated for another UE. For example, UE communicating component 342 can refrain from receiving over the first time resource location (at least for the SL transmitting UE 104-a that provided the comb pattern information to the SL receiving UE 104-b-e.g., in SCI) based on the comb pattern information indicating to refrain from receiving over the first time resource location that is overlapping, based on the comb pattern not configuring the first time resource location that is overlapping, etc.

In one example, as described above, in method 600, optionally at Block 614, a first time resource location of the time resource locations can be transmitted over using FDM with a second time resource location indicated for another UE based on the first time resource location overlapping the second time resource location. In an aspect, UE communicating component 342, e.g., in conjunction with processor(s) 312, memory 316, transceiver 302, etc., of a SL transmitting UE 104-a, can transmit over the first time resource location of the time resource locations using FDM with the second time resource location indicated for another UE based on the first time resource location overlapping the second time resource location. For example, comb configuring component 352 of a SL transmitting UE 104-a can also generate or modify the comb configuration to indicate the frequency resources used in FDM to transmit along with the second UE in the time resource location that is overlapping. For example, the frequency resources may include a frequency comb allocation, which may be indicated by parameters in the comb pattern indication (e.g., starting subcarrier or resource element (RE), number of REs between resource allocations, number of repetitions, etc.).

In method 700, optionally at Block 712, a first time resource location of the time resource locations can be received over, using FDM, with a second time resource location indicated for another UE based on the first time resource location overlapping with the second time resource location. In an aspect, UE communicating component 342, e.g., in conjunction with processor(s) 312, memory 316, transceiver 302, etc., of a SL receiving UE 104-b, can receive over the first time resource location of the time resource locations using FDM with the second time resource location indicated for another UE based on the first time resource location overlapping with the second time resource location. For example, UE communicating component 342 can receive over the first time resource location (at least for the SL transmitting UE 104-a that provided the comb pattern information to the SL receiving UE 104-b-e.g., in SCI) based on the comb pattern information indicating the portion of frequency in FDM that is allocated for the SL transmitting UE 104-a in the first time resource location. In another example, UE communicating component 342 may also receive over the second time resource location for another UE based on another portion of the frequency indicated for the another UE.

In another example, a comb pattern for a given UE can include non-contiguous data transmission in both the time and frequency domain, and may include AGC placement, as previously described. In this example, AGC symbol reservation can be similar as described above, and/or may be defined based on the comb pattern selected for the given UE. In one example, some REs can be reserved for AGC setting of a few selected UEs in each (or a few) of the symbols. Additional AGC symbols (e.g., more than a minimum number of AGC symbols, which in the above examples is either 1 for non-overlapping case or 3 for overlapping case) in a CPI may lead to more robust AGC setting. In one example, the PSCCH and/or PSSCH can be scheduled in different frequency resources for each UE (e.g., for transmission in an FDM manner, as described above), or can be scheduled across multiple non-contiguously placed subcarriers, e.g., in a frequency comb pattern (e.g., not just in overlapping time resource locations, but in each configured time resource location for the UE). For example, the PSCCH and/or PSSCH may be placed in one or multiple interspersed-subchannels (where, an interspersed-subchannel may be defined as M number of non-contiguous subcarriers).

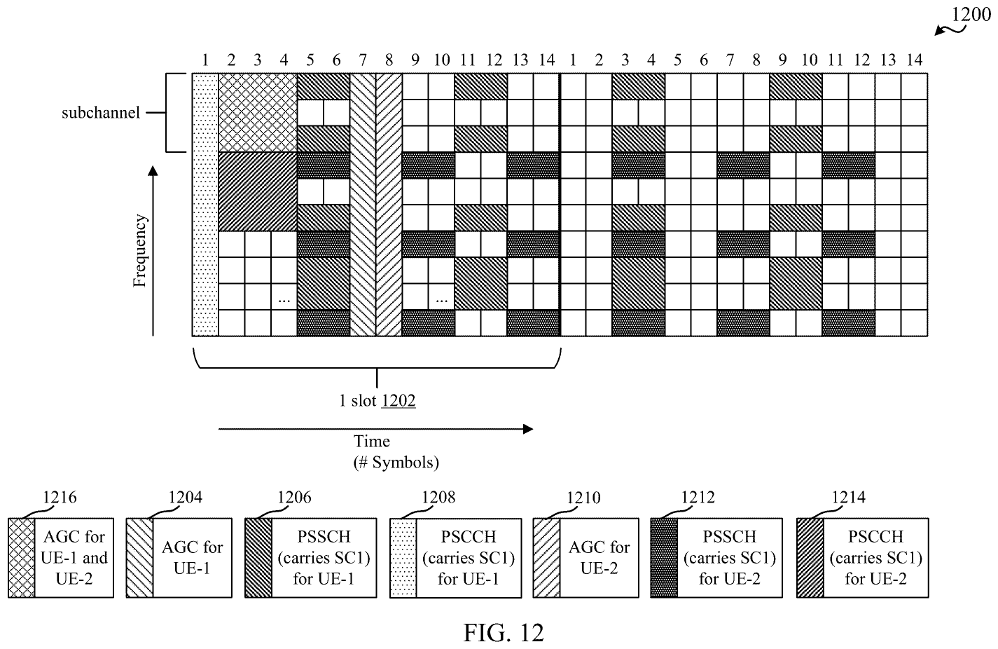

For example, as described above, the indication of the comb pattern can include one or more parameters that define the time resource locations of the comb pattern and/or the frequency resource locations of the comb pattern, and can be indicated in DCI (e.g., for Type 1 SL resource allocation) or SCI (e.g., for Type 2 SL resource allocation). For example, configuring component 452 can configure the indication of the comb pattern to a SL transmitting UE 104-a (and/or a SL receiving UE 104-b) including parameters to indicate a total number of REs, RE bitmap or parameters for given time-frequency comb type, start and end RE in the given bandwidth, etc. In another example, comb configuring component 352 of a SL transmitting UE 104-a can generate and/or transmit, and/or comb configuring component 352 of a SL receiving UE 104-b can receive and/or process, the indication of the comb pattern to a SL transmitting UE 104-a (and/or a SL receiving UE 104-b) including parameters to indicate a total number of REs, RE bitmap or parameters for given time-frequency comb type, start and end RE in the given bandwidth, etc. An example is shown in FIG. 12.

FIG. 12 illustrates an example of a resource allocation 1200 over a period of time, including a time and/or frequency comb pattern for multiple SL transmitting UEs, in accordance with aspects described herein. Resource allocation 1200 includes multiple slots, such as slot 1202, including multiple symbols (e.g., 14 symbols). A first slot (e.g., slot 1 1202) can include a common AGC symbol 1216 for a first UE (UE-1) and a second UE (UE-2), after which the multiple UEs can each transmit PSCCH in one or more slots, including one or more symbols that include PSCCH (including SCI) for UE-1 1208 and PSCCH (including SCI) for UE-2 1214 (e.g., symbols 2 and 3 of the first slot). The first slot can also include an AGC symbol for UE-1 1204 (e.g., symbol 7 of the first slot), and an AGC symbol for UE-2 1210 (e.g., symbol 8 of the first slot).

In addition, resource allocation 1200 includes a comb pattern of resources in time and frequency allocated to UE-1, which include non-contiguous resources in time in a uniform spacing or pattern of a number, K₁, symbols between each “tooth” or allocated symbol of the comb, and/or non-contiguous resources in frequency in a uniform spacing or pattern of a number, L₁, of REs between each “tooth” or allocated subcarrier/RE of the comb. For example, for UE-1, K₁=4 symbols with starting symbol 5 (and length of two symbols), and L₁=1 RE, for PSSCH communications 1206. For example, for UE-2, K₂=2 symbols with starting symbol 5 (and length of 2 symbols), and L₂=2 REs for PSSCH communications 1212, starting at a different RE than the PSSCH for UE-1 1206. In the depicted example, the REs for PSSCH for UE-1 1206 and PSSCH for UE-2 1212 do not overlap in frequency.

In one example, using a comb pattern in time can provide a higher velocity resolution with a same number of symbols spread in time. For example, using distributed mapping in time domain can enable sparse symbol reservation (e.g., sparser than mini-slot) in the time domain for efficient resource utilization between multiple UEs. For high resolution velocity estimation, symbols can be sent for large time intervals, and thus distributed mapping in time can reduce the number of symbols used for velocity estimation in sensing applications, as compared to localized time domain mapping. Velocity estimation for uniformly spaced symbols with wide inter-spacing and traditional single-fast Fourier transform (FFT) processing may lead to lower maximum unambiguous velocity. Maximum unambiguous velocity, however, can be increased in distributed mapping by one or more of the following: transmitter (e.g., SL transmitting UE) design using non-uniform placement of symbols, higher comb (e.g., comb-2) in the first few symbols, followed by lower comb (e.g., comb-1) in later symbols; or receiver (e.g., SL receiving UE) design using multi-hypothesis algorithm with different Doppler hypothesis.

FIG. 13 is a block diagram of a MIMO communication system 1300 including UEs 104-a, 104-b. The MIMO communication system 1300 may illustrate aspects of the wireless communication access network 100 described with reference to FIG. 1. The UE 104-a may be an example of aspects of the UE 104 described with reference to FIGS. 1 and 3. The UE 104-a may be equipped with antennas 1334 and 1335, and the UE 104-b may be equipped with antennas 1352 and 1353. In the MIMO communication system 1300, the UEs 104-a, 104-b may be able to send data over multiple communication links at the same time. Each communication link may be called a “layer” and the “rank” of the communication link may indicate the number of layers used for communication. For example, in a 2×2 MIMO communication system where UE 104-a transmits two “layers,” the rank of the communication link between the UE 104-a and the UE 104-b is two.

At the UE 104-a, a transmit (Tx) processor 1320 may receive data from a data source. The transmit processor 1320 may process the data. The transmit processor 1320 may also generate control symbols or reference symbols. A transmit MIMO processor 1330 may perform spatial processing (e.g., precoding) on data symbols, control symbols, or reference symbols, if applicable, and may provide output symbol streams to the transmit modulator/demodulators 1332 and 1333. Each modulator/demodulator 1332 through 1333 may process a respective output symbol stream (e.g., for OFDM, etc.) to obtain an output sample stream. Each modulator/demodulator 1332 through 1333 may further process (e.g., convert to analog, amplify, filter, and upconvert) the output sample stream to obtain a DL signal. In one example, DL signals from modulator/demodulators 1332 and 1333 may be transmitted via the antennas 1334 and 1335, respectively.

The UE 104-b may be an example of aspects of the UEs 104 described with reference to FIGS. 1 and 3. At the UE 104-b, the UE antennas 1352 and 1353 may receive the signals from the UE 104-a (e.g., over a sidelink) and may provide the received signals to the modulator/demodulators 1354 and 1355, respectively. Each modulator/demodulator 1354 through 1355 may condition (e.g., filter, amplify, downconvert, and digitize) a respective received signal to obtain input samples. Each modulator/demodulator 1354 through 1355 may further process the input samples (e.g., for OFDM, etc.) to obtain received symbols. A MIMO detector 1356 may obtain received symbols from the modulator/demodulators 1354 and 1355, perform MIMO detection on the received symbols, if applicable, and provide detected symbols. A receive (Rx) processor 1358 may process (e.g., demodulate, deinterleave, and decode) the detected symbols, providing decoded data for the UE 104-b to a data output, and provide decoded control information to a processor 1380, or memory 1382.

At the UE 104-b, a transmit processor 1364 may receive and process data from a data source. The transmit processor 1364 may also generate reference symbols for a reference signal. The symbols from the transmit processor 1364 may be precoded by a transmit MIMO processor 1366 if applicable, further processed by the modulator/demodulators 1354 and 1355 (e.g., for SC-FDMA, etc.), and be transmitted to the UE 104-a in accordance with the communication parameters received from the UE 104-a. At the UE 104-a, the signals from the UE 104-b may be received by the antennas 1334 and 1335, processed by the modulator/demodulators 1332 and 1333, detected by a MIMO detector 1336 if applicable, and further processed by a receive processor 1338. The receive processor 1338 may provide decoded data to a data output and to the processor 1340 or memory 1342.

The processor 1340 and/or 1380 may in some cases execute stored instructions to instantiate a UE communicating component 342 (see e.g., FIGS. 1 and 3).

The components of the UEs 104-a, 104-b may, individually or collectively, be implemented with one or more ASICs adapted to perform some or all of the applicable functions in hardware. Each of the noted modules may be a means for performing one or more functions related to operation of the MIMO communication system 1300. Similarly, the components of the UE 104-a may, individually or collectively, be implemented with one or more ASICs adapted to perform some or all of the applicable functions in hardware. Each of the noted components may be a means for performing one or more functions related to operation of the MIMO communication system 1300.

The following aspects are illustrative only and aspects thereof may be combined with aspects of other embodiments or teaching described herein, without limitation.

Aspect 1 is a method for wireless communication at a UE including obtaining an indication of a comb pattern including a collection of non-contiguous time resource locations for transmitting a radar signal that includes a data channel communication, and one of transmitting, using the comb pattern, the radar signal to one or more other UEs over sidelink shared channel resources, or receiving, using the comb pattern, the radar signal from one or more other UEs over the sidelink shared channel resources.

In Aspect 2, the method of Aspect 1 includes where the time resource locations correspond to symbols over a period of time, and where the comb pattern includes, at a starting symbol, a uniform spacing of symbols corresponding to the time resource locations over the period of time.

In Aspect 3, the method of Aspect 2 includes one of transmitting one or more of an AGC symbol or a PSCCH in the period of time and before the starting symbol of the comb pattern, or receiving one or more of the AGC symbol or the PSCCH in the period of time and before the starting symbol of the comb pattern.

In Aspect 4, the method of Aspect 3 includes one of transmitting, within the period of time and before the one or more of the AGC symbol or the PSCCH, a common AGC symbol with other UEs, or receiving, within the period of time and before the one or more of the AGC symbol or the PSCCH, the common AGC symbol with other UEs.

In Aspect 5, the method of any of Aspects 2 to 4 includes where obtaining the indication of the comb pattern includes receiving the indication of the comb pattern in DCI signaling from a network node.

In Aspect 6, the method of any of Aspects 2 to 5 includes transmitting the indication of the comb pattern to the one or more other UEs in SCI.

In Aspect 7, the method of any of Aspects 2 to 6 includes where obtaining the indication of the comb pattern includes receiving the indication of the comb pattern from the one or more other UEs in SCI.

In Aspect 8, the method of any of Aspects 2 to 7 includes where the indication of the comb pattern includes a value indicating one or more of an index of the starting symbol, the uniform spacing, an index of a last symbol in the period of time, a value of the total number of symbols in the period of time, a number of periods of time that follow the comb pattern, a repetition pattern for the periods of time, or a stop symbol index from a start of the period of time within which the starting symbol is to be defined.

In Aspect 9, the method of any of Aspects 1 to 8 includes where the time resource locations correspond to symbols over a period of time, and where the comb pattern includes, at a starting symbol, a non-uniform spacing of symbols corresponding to the time resource locations over the period of time.

In Aspect 10, the method of Aspect 9 includes where the non-uniform spacing of symbols is defined as a multiple-level nested pattern.

In Aspect 11, the method of any of Aspects 9 or 10 includes one of refraining from transmitting over a first time resource location of the time resource locations based on the first time resource location overlapping with a second time resource location indicated for another UE, or refraining from receiving over the first time resource location of the time resource locations based on the first time resource location overlapping with the second time resource location indicated for another UE.

In Aspect 12, the method of any of Aspects 9 to 11 includes one of transmitting over a first time resource location of the time resource locations using FDM with a second time resource location indicated for another UE based on the first time resource location overlapping with the second time resource location, or receiving over the first time resource location of the time resource locations using FDM with the second time resource location indicated for another UE based on the first time resource location overlapping with the second time resource location.

In Aspect 13, the method of any of Aspects 9 to 12 includes one of transmitting one or more of an AGC symbol or a PSCCH in the period of time and before the starting symbol of the comb pattern, or receiving one or more of the AGC symbol or the PSCCH in the period of time and before the starting symbol of the comb pattern.

In Aspect 14, the method of Aspect 13 includes one of transmitting, within the period of time and before the one or more of the AGC symbol or the PSCCH, a common AGC symbol with other UEs, or receiving, within the period of time and before the one or more of the AGC symbol or the PSCCH, the common AGC symbol with other UEs.

In Aspect 15, the method of any of Aspects 9 to 14 includes where obtaining the indication of the comb pattern includes receiving the indication of the comb pattern in DCI signaling from a network node.

In Aspect 16, the method of any of Aspects 9 to 15 includes transmitting the indication of the comb pattern to the one or more other UEs in SCI.

In Aspect 17, the method of any of Aspects 9 to 16 includes where obtaining the indication of the comb pattern includes receiving the indication of the comb pattern from the one or more other UEs in SCI.

In Aspect 18, the method of any of Aspects 9 to 17 includes where the indication of the comb pattern includes a value indicating one or more of an index of the starting symbol, the uniform spacing, an index of a last symbol in the period of time, a value of the total number of symbols in the period of time, a number of periods of time that follow the comb pattern, a repetition pattern for the periods of time, or a stop symbol index from a start of the period of time within which the starting symbol is to be defined.

In Aspect 19, the method of any of Aspects 9 to 18 includes where obtaining the indication of the comb pattern includes receiving the indication of the comb pattern in a resource pool configuration, where the indication of the comb pattern includes a value indicating, within the resource pool, the uniform spacing and another value indicating a second uniform spacing for another UE.

In Aspect 20, the method of any of Aspects 1 to 19 includes where the comb pattern further includes a collection of non-contiguous frequency resource locations for transmitting the radar signal.

In Aspect 21, the method of Aspect 20 includes where the time resource locations correspond to symbols over a period of time, and where the comb pattern includes, at a starting symbol, a spacing of symbols corresponding to the time resource locations over the period of time.

In Aspect 22, the method of Aspect 21 includes one of transmitting one or more of an AGC symbol or a PSCCH in the period of time and before the starting symbol of the comb pattern, or receiving one or more of the AGC symbol or the PSCCH in the period of time and before the starting symbol of the comb pattern.

In Aspect 23, the method of Aspect 22 includes one of transmitting, within the period of time and before the one or more of the AGC symbol or the PSCCH, a common AGC symbol with other UEs, or receiving, within the period of time and before the one or more of the AGC symbol or the PSCCH, the common AGC symbol with other UEs.

In Aspect 24, the method of any of Aspects 22 or 23 includes where a time or frequency location of the AGC symbol is based on the comb pattern.

In Aspect 25, the method of any of Aspects 22 to 24 includes where one of transmitting the PSCCH includes transmitting using FDM with a second PSCCH from another UE, or receiving the PSCCH includes receiving using FDM with a second PSCCH from another UE.

In Aspect 26, the method of any of Aspects 22 to 25 includes where one of transmitting the PSCCH includes transmitting the PSCCH over multiple non-contiguous frequency locations, or receiving the PSCCH includes receiving the PSCCH over multiple non-contiguous frequency locations.

In Aspect 27, the method of any of Aspects 21 to 26 includes where obtaining the indication of the comb pattern includes receiving the indication of the comb pattern in DCI signaling from a network node.

In Aspect 28, the method of any of Aspects 21 to 27 includes transmitting the indication of the comb pattern to the one or more other UEs in SCI.

In Aspect 29, the method of any of Aspects 21 to 28 includes where obtaining the indication of the comb pattern includes receiving the indication of the comb pattern to the one or more other UEs in SCI.

In Aspect 30, the method of any of Aspects 21 to 29 includes where the indication of the comb pattern includes a value indicating one or more of an index of the starting symbol, the uniform spacing, an index of a last symbol in the period of time, a value of the total number of symbols in the period of time, a number of periods of time that follow the comb pattern, a repetition pattern for the periods of time, or a stop symbol index from a start of the period of time within which the starting symbol is to be defined.

Aspect 31 is a method for wireless communication at a network node including generating a comb pattern for multiple UEs to use in transmitting, over sidelink resources, a radar signal that includes a data channel communication, and transmitting, to the multiple UEs, downlink control information including an indication of the comb pattern, where the comb pattern includes a collection of non-contiguous time resource locations for transmitting the radar signal.

In Aspect 32, the method of Aspect 31 includes where the time resource locations correspond to symbols over a period of time, and where the comb pattern includes, at a starting symbol, a uniform spacing of symbols corresponding to the time resource locations over the period of time.

In Aspect 33, the method of Aspect 32 includes transmitting, to the multiple UEs, an indication of a symbol location for each UE of the multiple UEs to transmit one or more of an AGC symbol or a PSCCH in the period of time and before the starting symbol of the comb pattern.

In Aspect 34, the method of Aspect 33 includes transmitting, to the multiple UEs, an indication of a second symbol location for transmitting a common AGC symbol within the period of time and before the one or more of the AGC symbol or the PSCCH.

In Aspect 35, the method of any of Aspects 33 or 34 includes where the indication of the comb pattern includes a value indicating one or more of an index of the starting symbol, the uniform spacing, an index of a last symbol in the period of time, a value of the total number of symbols in the period of time, a number of periods of time that follow the comb pattern, or a repetition pattern for the periods of time.

In Aspect 36, the method of any of Aspects 33 to 35 includes where the indication of the comb pattern includes an indication of a stop symbol index from a start of the period of time within which the starting symbol is to be defined.

In Aspect 37, the method of any of Aspects 33 to 36 includes where the indication of the comb patterns includes a first indication of a first comb pattern for a first UE of the multiple UEs and a second indication of a second comb pattern for a second UE of the multiple UEs.

In Aspect 38, the method of Aspect 37 includes where the first indication includes a first uniform pattern period for the time resource locations of the first comb pattern, and where the second indication includes a second uniform pattern period for the time resource locations of the second comb pattern, where the first uniform pattern period is different from the second uniform pattern period.

In Aspect 39, the method of any of Aspects 37 or 38 includes where the first indication includes a first uniform pattern period for the first comb pattern, and where the second indication includes an indication of non-uniform symbol spacing corresponding to the time resource locations for the second comb pattern.

In Aspect 40, the method of Aspect 39 includes where the non-uniform symbol spacing is defined as a multiple-level nested pattern.

In Aspect 41, the method of any of Aspects 37 to 40 includes, where a first time resource location of the time resource locations associated with the first comb pattern overlaps a second time resource location of the time resource locations associated with the second comb pattern, allocating FDM resources for the first time resource location and the second time resource location.

In Aspect 42, the method of any of Aspects 37 to 41 includes transmitting, to the multiple UEs, an indication of a symbol location for transmitting a common AGC symbol within the period of time and before the one or more of the AGC symbol or the PSCCH.

In Aspect 43, the method of any of Aspects 37 to 42 includes where the first indication of the first comb pattern includes a first value indicating one or more of an index of a first starting symbol, a first uniform spacing, an index of a last symbol in the period of time for the first comb pattern, a value of the total number of symbols in the period of time for the first comb pattern, a number of periods of time that follow the first comb pattern, or a repetition pattern for the periods of time for the first comb pattern, and where the second indication of the second comb pattern includes a second value indicating one or more of an index of a second starting symbol, a second uniform spacing, an index of a last symbol in the period of time for the second comb pattern, a value of the total number of symbols in the period of time for the second comb pattern, a number of periods of time that follow the second comb pattern, or a repetition pattern for the periods of time for the second comb pattern.

In Aspect 44, the method of any of Aspects 37 to 43 includes where transmitting the indication includes transmitting the first indication and the second indication in a resource pool configuration.

In Aspect 45, the method of any of Aspects 33 to 44 includes where the comb pattern includes a collection of non-contiguous time resource locations and non-contiguous frequency resource locations for transmitting the radar signal.

In Aspect 46, the method of Aspect 45 includes where the time resource locations correspond to symbols over a period of time, and where the comb pattern includes, at a starting symbol, a spacing of symbols corresponding to the time resource locations over the period of time.

In Aspect 47, the method of Aspect 46 includes transmitting, to the multiple UEs, an indication of a symbol location for each UE of the multiple UEs to transmit one or more of an AGC symbol or a PSCCH in the period of time and before the starting symbol of the comb pattern.

In Aspect 48, the method of Aspect 47 includes transmitting, to the multiple UEs, an indication of a symbol location for transmitting a common AGC symbol within the period of time and before the one or more of the AGC symbol or the PSCCH.

In Aspect 49, the method of any of Aspects 47 or 48 includes where a time or frequency location of the AGC symbol is based on the comb pattern.

In Aspect 50, the method of any of Aspects 47 to 49 includes where the indication includes a first frequency resource location for PSCCH for a first UE of the multiple UEs and a second frequency resource location for PSCCH of a second UE of the multiple UEs, where the first frequency resource location and the second frequency resource location are frequency division multiplexed in a same time resource location.

In Aspect 51, the method of any of Aspects 47 to 50 includes where the indication of the symbol location for the PSCCH includes multiple non-contiguous frequency locations for the PSCCH.

In Aspect 52, the method of any of Aspects 46 to 51 includes where the indication of the comb pattern includes a value indicating one or more of an index of the starting symbol, the uniform spacing, an index of a last symbol in the period of time, a value of the total number of symbols in the period of time, a number of periods of time that follow the comb pattern, or a repetition pattern for the periods of time.

Aspect 53 is an apparatus for wireless communication including a processor, memory coupled with the processor, and instructions stored in the memory and operable, when executed by the processor, to cause the apparatus to perform any of the methods of Aspects 1 to 52.

Aspect 54 is an apparatus for wireless communication including means for performing any of the methods of Aspects 1 to 52.

Aspect 55 is a computer-readable medium including code executable by one or more processors for wireless communications, the code including code for performing any of the methods of Aspects 1 to 52.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. An apparatus for wireless communication, comprising:
a processor;
memory coupled with the processor; and
instructions stored in the memory and operable, when executed by the processor, to cause the apparatus to:
obtain an indication of a comb pattern including a collection of noncontiguous time resource locations for transmitting a radar signal that includes a data channel communication; and
one of:
transmit, using the comb pattern, the radar signal to one or more other user equipment (UEs) over sidelink shared channel resources; or receive, using the comb pattern, the radar signal from one or more other UEs over the sidelink shared channel resources.

2. The apparatus of claim 1, wherein the time resource locations correspond to symbols over a period of time, and wherein the comb pattern includes, at a starting symbol, a uniform spacing of symbols corresponding to the time resource locations over the period of time.

3. (canceled)

4. The apparatus of claim 2, wherein the instructions, when executed by the processor, cause the apparatus to obtain the indication of the comb pattern at least in part by receiving the indication of the comb pattern in one of downlink control information (DCI) signaling from a network node or sidelink control information from the one or more other UEs.

5. (canceled)

6. The apparatus of claim 2, wherein the indication of the comb pattern includes a value indicating one or more of an index of the starting symbol, the uniform spacing, an index of a last symbol in the period of time, a value of a total number of symbols in the period of time, a number of periods of time that follow the comb pattern, a repetition pattern for the periods of time, or a stop symbol index from a start of the period of time within which the starting symbol is to be defined.

7. The apparatus of claim 1, wherein the time resource locations correspond to symbols over a period of time, and wherein the comb pattern includes, at a starting symbol, a non-uniform spacing of symbols corresponding to the time resource locations over the period of time.

8. The apparatus of claim 7, wherein the non-uniform spacing of symbols is defined as a multiple-level nested pattern.

9. The apparatus of claim 7, wherein the instructions, when executed by the processor, cause the apparatus to one of:
refrain from transmitting over a first time resource location of the time resource locations based on the first time resource location overlapping with a second time resource location indicated for another UE;
refrain from receiving over the first time resource location of the time resource locations based on the first time resource location overlapping with the second time resource location indicated for another UE;
transmit over a first time resource location of the time resource locations using frequency division multiplexing (FDM) with a second time resource location indicated for another UE based on the first time resource location overlapping with the second time resource location; or receive over the first time resource location of the time resource locations using FDM with the second time resource location indicated for another UE based on the first time resource location overlapping with the second time resource location.

10. The apparatus of claim 7, wherein the instructions, when executed by the processor, cause the apparatus to one of:
transmit one or more of an automatic gain control (AGC) symbol or a physical sidelink control channel (PSCCH) in the period of time and before the starting symbol of the comb pattern;
receive one or more of the AGC symbol or the PSCCH in the period of time and before the starting symbol of the comb pattern;
transmit, within the period of time and before the one or more of the AGC symbol or the PSCCH, a common AGC symbol with other UEs; or receive, within the period of time and before the one or more of the AGC symbol or the PSCCH, the common AGC symbol with other UEs.

11. The apparatus of claim 7, wherein the instructions, when executed by the processor, cause the apparatus to obtain the indication of the comb pattern at least in part by receiving the indication of the comb pattern in downlink control information (DCI) signaling from a network node or in sidelink control information (SCI) from the one or more other UEs.

12. (canceled)

13. The apparatus of claim 7, wherein the indication of the comb pattern includes a value indicating one or more of an index of the starting symbol, an index of a last symbol in the period of time, a value of a total number of symbols in the period of time, a number of periods of time that follow the comb pattern, a repetition pattern for the periods of time, or a stop symbol index from a start of the period of time within which the starting symbol is to be defined.

14. The apparatus of claim 7, wherein the instructions, when executed by the processor, cause the apparatus to obtain the indication of the comb pattern at least in part by receiving the indication of the comb pattern in a resource pool configuration, wherein the indication of the comb pattern includes a value indicating, within the resource pool, and another value indicating a second uniform spacing for another UE.

15. The apparatus of claim 1, wherein the comb pattern further includes a collection of non-contiguous frequency resource locations for transmitting the radar signal, wherein the time resource locations correspond to symbols over a period of time, and wherein the comb pattern includes, at a starting symbol, a spacing of symbols corresponding to the time resource locations over the period of time.

16. The apparatus of claim 15, wherein the instructions, when executed by the processor, cause the apparatus to one of:
transmit one or more of an automatic gain control (AGC) symbol or a physical sidelink control channel (PSCCH) in the period of time and before the starting symbol of the comb pattern;
receive one or more of the AGC symbol or the PSCCH in the period of time and before the starting symbol of the comb pattern;
transmit, within the period of time and before the one or more of the AGC symbol or the PSCCH, a common AGC symbol with other UEs; or receive, within the period of time and before the one or more of the AGC symbol or the PSCCH, the common AGC symbol with other UEs.

17. The apparatus of claim 16, wherein a time or frequency location of the AGC symbol is based on the comb pattern.

18-20. (canceled)

21. The apparatus of claim 16, wherein the indication of the comb pattern includes a value indicating one or more of an index of the starting symbol, an index of a last symbol in the period of time, a value of a total number of symbols in the period of time, a number of periods of time that follow the comb pattern, a repetition pattern for the periods of time, or a stop symbol index from a start of the period of time within which the starting symbol is to be defined.

22. An apparatus for wireless communication, comprising:
a processor;
memory coupled with the processor; and
instructions stored in the memory and operable, when executed by the processor, to cause the apparatus to:
generate a comb pattern for multiple user equipment (UEs) to use in transmitting, over sidelink resources, a radar signal that includes a data channel communication; and
transmit, to the multiple UEs, downlink control information including an indication of the comb pattern,
wherein the comb pattern includes a collection of non-contiguous time resource locations for transmitting the radar signal.

23. The apparatus of claim 22, wherein the time resource locations correspond to symbols over a period of time, and wherein the comb pattern includes, at a starting symbol, a uniform spacing of symbols corresponding to the time resource locations over the period of time.

24. The apparatus of claim 23, wherein the instructions, when executed by the processor, cause the apparatus to transmit, to the multiple UEs, an indication of a symbol location for each UE of the multiple UEs to transmit one or more of an automatic gain control (AGC) symbol or a physical sidelink control channel (PSCCH) in the period of time and before the starting symbol of the comb pattern.

25. The apparatus of claim 24, wherein the instructions, when executed by the processor, cause the apparatus to transmit, to the multiple UEs, an indication of a second symbol location for transmitting a common AGC symbol within the period of time and before the one or more of the AGC symbol or the PSCCH.

26. (canceled)

27. A method for wireless communication at a user equipment (UE), comprising:
obtaining an indication of a comb pattern including a collection of non-contiguous time resource locations for transmitting a radar signal that includes a data channel communication; and
one of:
transmitting, using the comb pattern, the radar signal to one or more other UEs over sidelink shared channel resources; or
receiving, using the comb pattern, the radar signal from one or more other UEs over the sidelink shared channel resources.

28-30. (canceled)
